(19) United States
(12) Patent Application Publication
(10) Pub. No.: US 2010/0322696 A1
(43) Pub. Date: Dec. 23, 2010

(54) PEN WITH WINDOW FOR DISPLAY OF PATTERN

(76) Inventor: Yu-Yin LIU, Taipei (TW)

Correspondence Address: Muncy, Geissler, Olds & Lowe, PLLC, 4000 Legato Road, Suite 310, FAIRFAX, VA, 22033, US

(21) Appl. No.: 12/649,068

(22) Filed: Dec. 29, 2009

(30) Foreign Application Priority Data
Jun. 22, 2009 (TW) 098120893

(51) Int. Cl. B43K 7/00; B43K 29/00

(52) U.S. Cl. 401/99; 401/195

(57) ABSTRACT

A pen with windows for display of patterns at random is revealed. The pen consists of a pen holder, at least one window disposed on the pen holder, a first control part and a second control part operated outside the pen holder. At least one rotating part with a plurality of patterns, a driving member and a stopping member are respectively mounted in the pen holder. The first control part is operated for driving the rotating part to rotate by the driving member. Then operate the second control part so as to stop the rotating part by the stopping member and one of the patterns is displayed through the window.

### BACKGROUND OF THE INVENTION

The present invention relates to a pen with at least one window that displays patterns randomly, especially to a pen in which at least one rotating part is controlled to view patterns at random.

There are various writing instruments available on the market such as pencils, ballpoint pens, roller ball pens, markers, colored pens, etc. The design and appearance of these pens are monotonous and boring. Except writing, no other functions such as amusement are provided.

In order to provide novelty and interesting uses, some pens include pens holders with curved design, made from flexible materials, or formed by a plurality of rotatable rings so as to increase interests. However, above designs only improve the appearance and people still have fewer interests in them. There is a need to satisfy people's requirements for novelty and innovation.

Moreover, there is a pen designed with three rollers therein. Three long through holes are arranged at a pen holder and a pull rod stud is set on a top of the pen holder. Each roller corresponds to a set of three locating parts and a recovery member. By pulling the pull stud, the respective roller rotates and presses against each locating part to be stopped respectively. Patterns on the rollers are shown by the long through holes. Then push the recovery member so as to repeat the above steps for improving interests of pens. However, the above pens include many parts and the structure is complicated. Thus the pens holder needs larger volume to receive these parts and the larger volume results in inconvenience in carrying and writing. In practice, the operation is also inconvenient and consuming. This reduces the willingness of users to use.

In order to meet requirements of novelty and innovation, there is a need to provide a pen with features of novel design, amusement effects, convenient operation and easy carrying.

### SUMMARY OF THE INVENTION

Therefore it is a primary object of the present invention to provide a pen with windows for display of patterns randomly that includes a pen holder, at least one rotating part, a driving member and a stopping member. At least one window corresponding to the rotating part is disposed on the surface of the pen holder. And the pen holder is further arranged projectingly with a first control part and a second control part for operation of the pen. The rotatable rotating part with a pattern surface is mounted in the pen holder. The pattern surface is disposed with a plurality of patterns. The driving member whose front end connects with a pen refill is mounted in the pen holder. A plurality of teeth that rests against the rotating part is set on a middle part of the driving member and the rear end of the driving member is connected with the first control part. The stopping member mounted in the pen holder is arranged with at least one stopping part that abuts against the rotating part while the rear end of the stopping member is connected with the second control part. By operating the first control part, the driving member is driven to move toward the front end of the pen holder so that the pen refill extends out of an opening on the front end of the pen holder to be ready for writing and also drives the rotating part to rotate. Moreover, by operating the second control part, the rotating part stops rotating by the stopping member so that one of the patterns on the pattern surface of the rotating part is displayed through the window(s) on the pen holder. Thus a pen having windows with features of novel design, interesting effects, convenient operation and easy carrying is provided.

It is another object of the present invention to provide a pen with windows for display of patterns at random in which the rotating part is a disk with a shaft and a brake part. Two ends of the shaft are sleeved with two symmetrical axial bases on the inner surfaces of the lens holder so that the rotating part rotates around the shaft. The brake part is arranged directly around the shaft, corresponding to the driving member and the stopping member so as to drive or stop the rotating part respectively.

### BRIEF DESCRIPTION OF THE DRAWINGS

FIG. 1 is a perspective view of an embodiment of a pen with windows according to the present invention;

FIG. 2 is a bottom view of an embodiment of a pen with windows according to the present invention;

FIG. 3 is a partial explosive view of the embodiment in FIG. 1;

FIG. 4 is a partial explosive view of the embodiment in FIG. 2;

FIG. 5 is an explosive view of the embodiment in FIG. 1;

FIG. 6 is an explosive view of the embodiment in FIG. 2;

FIG. 7 is a status of an embodiment before rotation according to the present invention;

FIG. 8 is a status showing rotating parts being driven to rotate according to the present invention;

FIG. 9 is a status showing that rotating parts stop rotation according to the present invention;

FIG. 10 is an explosive view of another embodiment according to the present invention.

### DETAILED DESCRIPTION OF THE PREFERRED EMBODIMENT

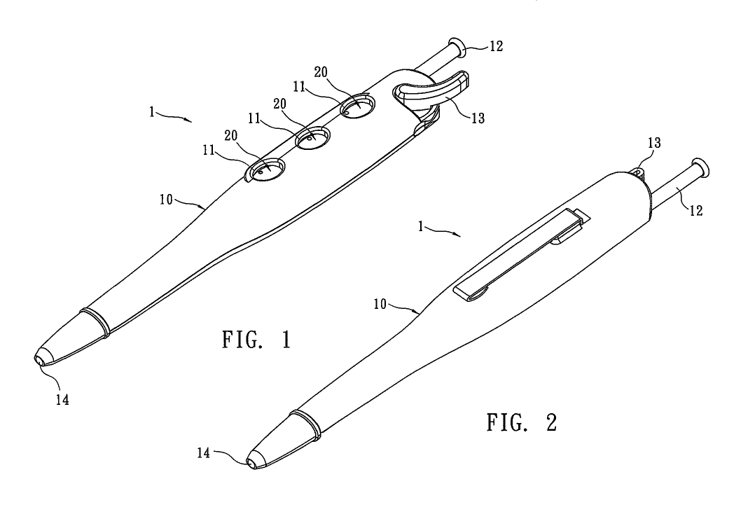

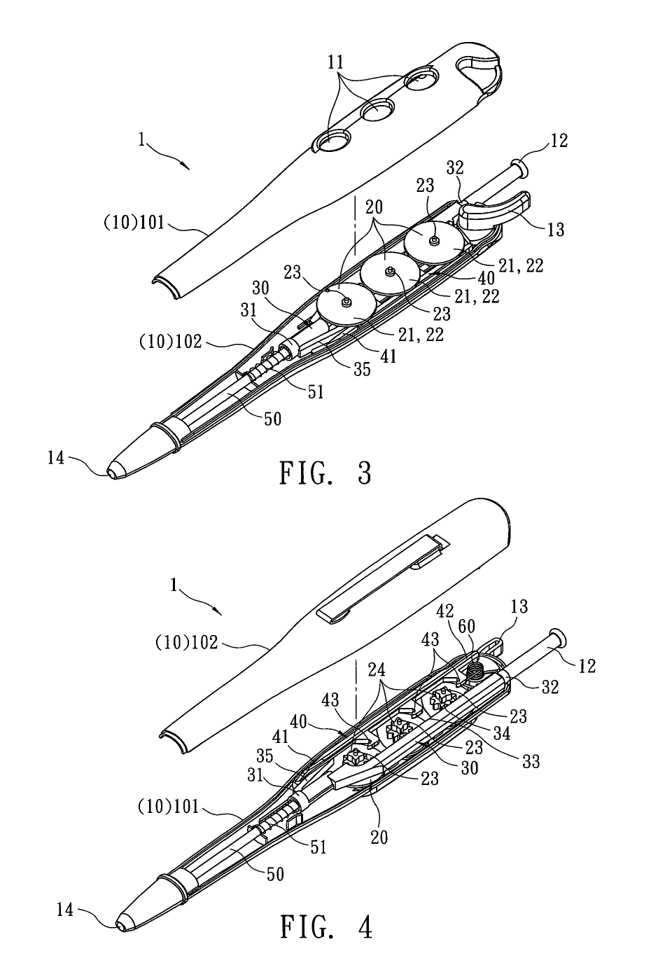

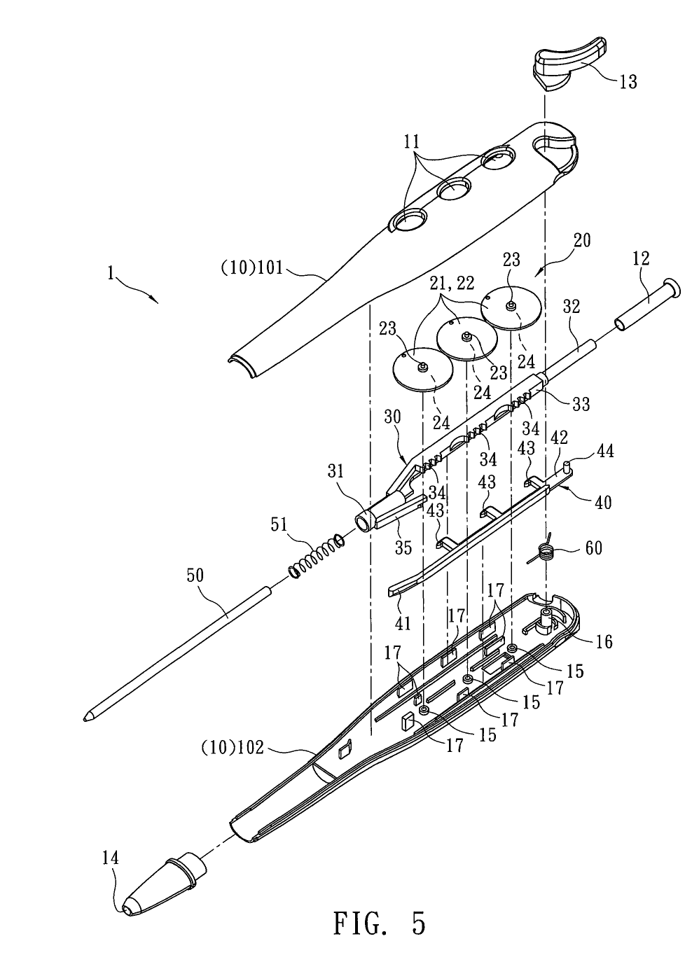

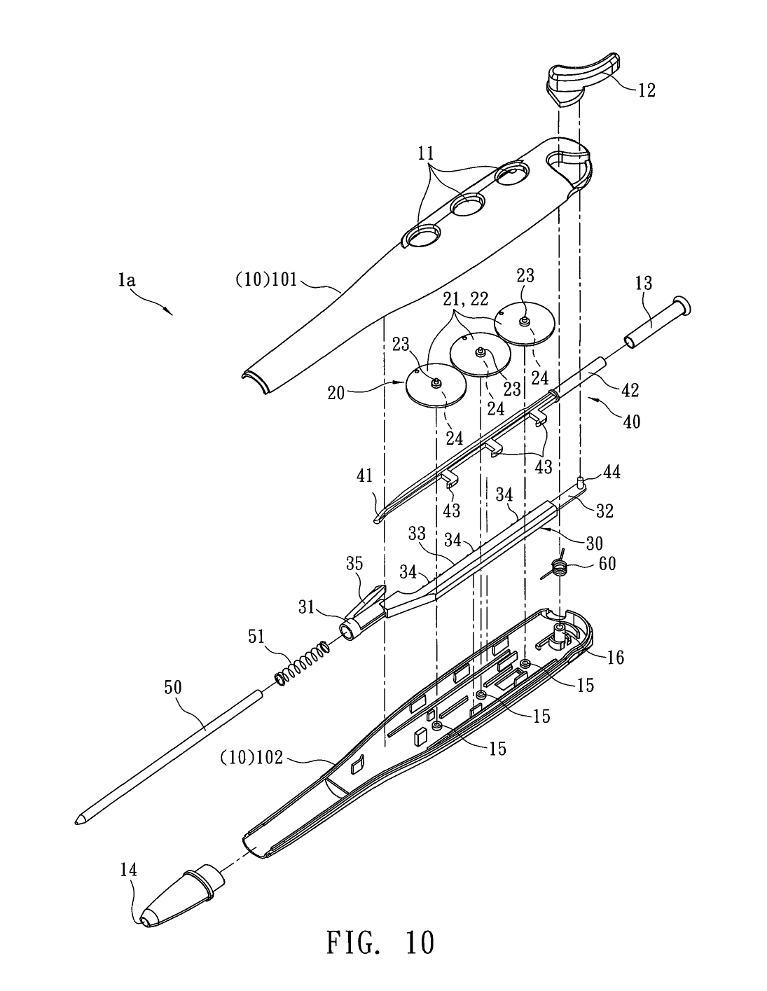

Refer from FIG. 1 to FIG. 6, a pen with windows include a pen holder 10, at least one rotating part 20, a driving member 30 and a stopping member 40. The pen holder 10 is composed of an upper housing and a lower housing 101, 102. At least one window 11 corresponding to the rotating part 20 is disposed on a surface of the pen holder 10 and two control parts such as a first control part 12, a second control part 13 are also arranged projectingly at the pen holder 10 for operation. An opening 14 is set on a front end of the pen holder 10. Inside the pen holder 10, there is a plurality of parts mounted therein. At least two symmetrical axial bases 15, a receiving seat 16 receiving the second control part 13 and having an elastic part 60 such as torsion coil spring arranged between the receiving seat 16 and the second control part 13. A lock 70 is corresponding to and locked with the driving member 30. A plurality of projecting plates 17 is used to regulate the movement of the driving member 30 as well as the stopping member 40. As to the first control part 12, and the second control part 13, they can be buttons or studs. As shown from FIG. 1 to FIG. 9, the first control part 12 is a button while the second control part 13 is a stud. Refer to FIG. 10, the first control part 12 is a stud and the second control part 13 is a button.

The rotating part 20 mounted in the pen holder 10 is a rotatable disk having a pattern surface 21, a shaft 23 and a brake part 24. The pattern surface 21 is coated with a plurality of patterns 22 that can be words, symbols, figures, colors or their combinations. When the rotating part 20 stops, the patterns 22 are displayed through the window 11 on the pen holder 10. Two ends of the shaft 23 are sleeved with two axial bases 15 on the inner surfaces of the lens holder 10. The brake part 24 is jagged teeth shaped and is disposed on the other surface, opposite to the pattern surface 21, and is arranged around the shaft 23 to be actuated by the driving member 30 and the stopping member 40 respectively.

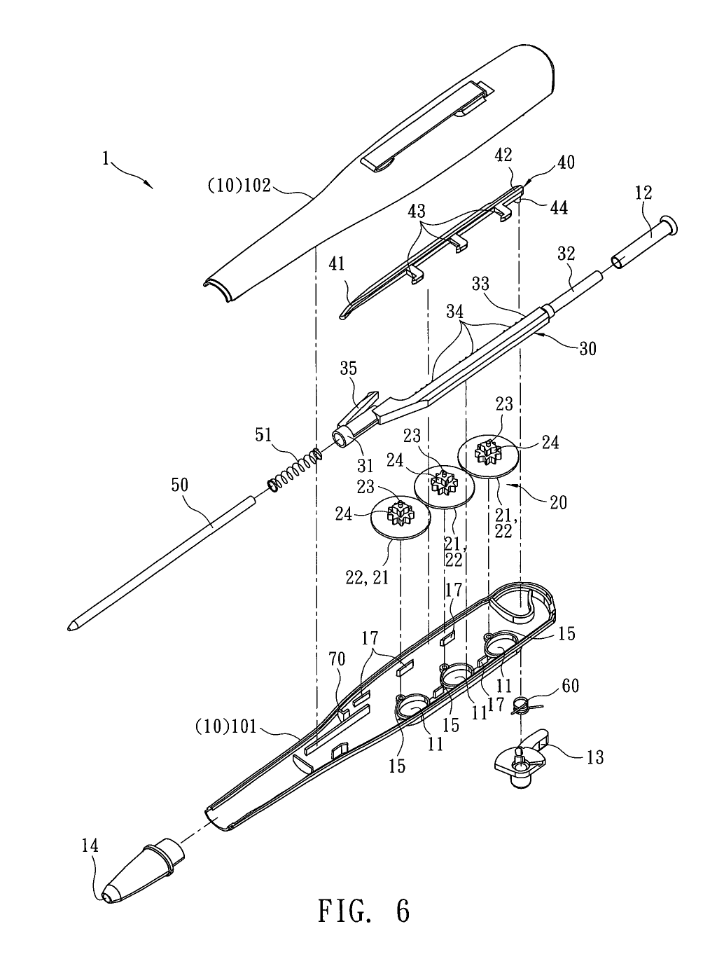

The driving member 30 that is a strip bar is set in the pen holder 10. A front end 31 thereof is connected with a pen refill 50 and a spring 51, wherein the pen refill 50 can elastically extends out or retracts of the opening 14 on the front end of the pen holder 10 by the spring 51 while a rear end 32 is connected with the first control part 12. A middle part 33 thereof is arranged with a plurality of teeth 34 that rest against the brake part 24 of the rotating part 20. By the teeth 34 against the brake part 24, the rotating part 20 is driven to rotate synchronously. By the plurality of projecting plates 17 on the inner surface of the pen holder 10, the driving member 30 is stopped and assembled on one side of the pen holder 10. The front end 31 of the driving member 30 is further disposed with a clip 35 slantingly that locks with the lock 70 on an inner side of the pen holder 10, as shown in FIG. 6.

The stopping member 40 is also a long strip mounted in the pen holder 10. A front end 41 thereof is a curved slant while a rear end 42 thereof is connected with the second control part 13. The stopping member 40 is arranged with at least one stopping part 43 such as a projection that abuts against the brake part 24 of the rotating part 20. When the stopping part 43 abuts against the brake part 24, the rotating part 20 is stopped and the pattern 22 on the pattern surface 21 thereof is viewed through the window 11. The rear end 42 of the stopping member 40 is further arranged with a bump 44 for connection with the second control part 13.

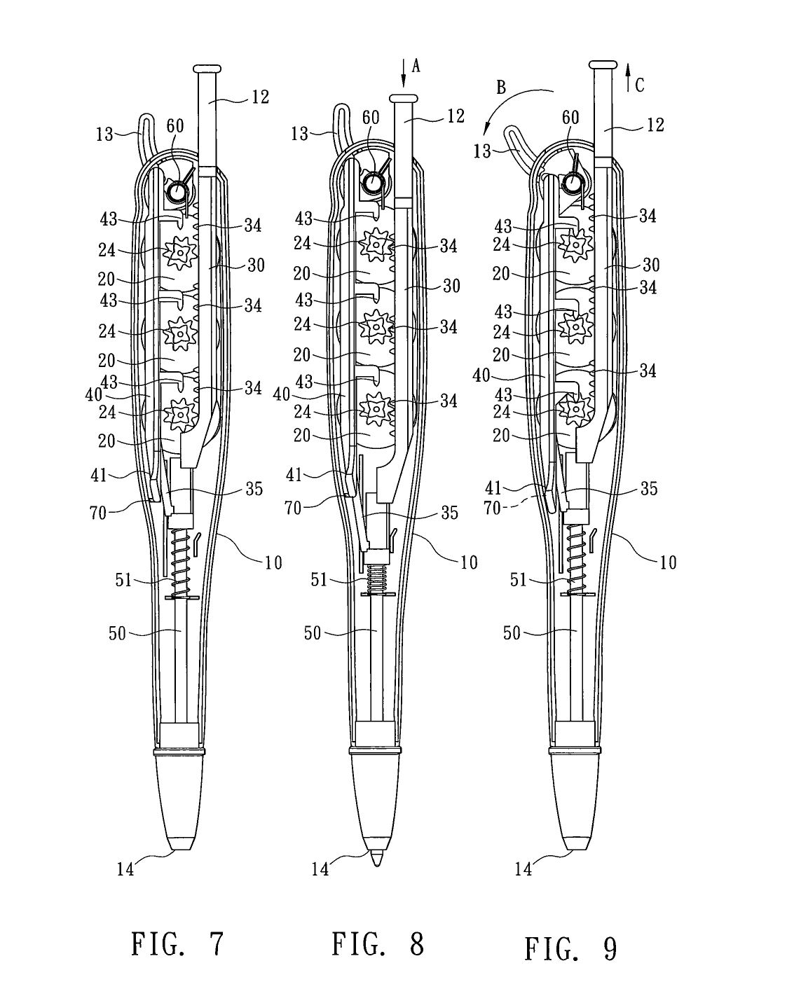

Refer to FIG. 7 and FIG. 8, by operating the first control part 12 (as the arrow A indicates in FIG. 8), the teeth 34 of the driving member 30 presses against the brake part 24 so as to drive the rotating part 20 rotating. At the same time, the driving member 30 moves forward to compress the spring 51 and push the pen refill 50 extends out of the opening 14 on the front end of the pen holder 10. Then the pen with windows 1 is ready for writing. Moreover, the clip 35 on the front end 31 of the driving member 30 leans against the lock 70 of the pen holder 10, in a locked state.

Refer to FIG. 9, by pressing the second control part 13 (as the arrow B indicates in FIG. 9), the stopping member 40 is driven to move and the stopping part 43 leans against the brake part 24 to form a brake that stops rotation of the rotating part 20. At the same time, by the movement of the stopping member 40, the front end 41 presses against the clip 35 on the front end 31 of the driving member 30 so that the clip 35 separates from the lock 70. And the driving member 30 moves backward (as the arrow C indicates in FIG. 9) due to extension of the spring 51 so as to drive the pen refill 50 to retract. Furthermore, the second control part 13 turns back to the original position by elasticity of the elastic part 60, as shown in FIG. 7.

Refer to FIG. 10, the rear end of the driving member 30 is further arranged with a bump 44 that is sleeved with the first control par 12 (designed as a stud). The rear end 42 of the stopping member 40 is connected with the second control part 13 (designed as a button).

In use, the first control part 12 is operated to drive the driving member 30 moving toward the front end of the pen holder 10 so as to drive the rotating part 20 rotating. And the pen refill 50 extends out of the opening 14 on the front end of the pen holder 10 to be ready for writing. Then by operating the second control part 13, the rotating part 20 stops rotating by the stopping member 40 so that one of the patterns 22 on the pattern surface 21 of the rotating part 20 is displayed through the window(s) 11 on the pen holder 10. User can see various patterns 22 within the windows 11. Thus the pen with windows 1 becomes more interesting.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A pen with at least one window for display of patterns randomly comprising:
a pen holder whose surface is disposed with at least one window, a first control part as well as a second control part for operation of the pen;
at least one rotatable rotating part mounted in the pen holder and having a pattern surface arranged with a plurality of patterns; one of the patterns is displayed through the window of the house when the rotating part stops rotating;
a driving member arranged in the pen holder and used to drive the rotating part rotating under control of the first control part;
a stopping member disposed in the pen holder and controlled by the operation of the second control part to stop rotation of the rotating part.

2. The device as claimed in claim 1, wherein the driving member is a strip bar and a front end thereof is connected with a pen refill, a middle part thereof is arranged with a plurality of teeth that rest against the rotating part, while a rear end is connected with the first control part; by operation of the first control part, the driving member is driven to move toward a front end of the pen holder so as to make the pen refill extend out of an opening on the front end of the pen holder.

3. The device as claimed in claim 1, wherein the stopping member is a long strip and is arranged with at least one stopping part that abuts against the rotating part while the stopping part is a projection.

4. The device as claimed in claim 1, wherein the rotating part is a disk having a shaft and a brake part while two ends of the shaft are rotatably sleeved with two symmetrical axial bases on the inner surfaces of the lens holder and the brake part is sleeved with the shaft, against the driving member and the stopping member respectively and correspondingly.

5. The device as claimed in claim 4, wherein the brake part is jagged teeth shaped.

6. The device as claimed in claim 1, wherein the patterns on the pattern surface are words, symbols, figures, colors or their combinations.

7. The device as claimed in claim 1, wherein the first control part and the second control part are buttons or studs.

8. The device as claimed in claim 1, wherein a receiving seat is disposed on an inner surface of the pen holder for receiving the second control part and an elastic part is arranged between the receiving seat and the second control part.

9. The device as claimed in claim 1, wherein a front end of the driving member is further disposed with a clip slantingly.

10. The device as claimed in claim 1, wherein front end of the stopping member is a curved slant while a rear end thereof is arranged with a bump.

11. The device as claimed in claim 1, wherein the pen holder includes an upper housing and a lower housing and at least one window corresponding to the rotating part is disposed on an outer surface of the upper housing.

12. The device as claimed in claim 1, wherein a plurality of projecting plates used to regulate the movement of the driving member as well as the stopping member is disposed on an inner surface of the pen holder.
